(19) United States
(12) Patent Application Publication
(10) Pub. No.: US 2011/0019057 A1
(43) Pub. Date: Jan. 27, 2011

(54) Electronic Playback Apparatus with a Micro-Projector

(75) Inventor: Chien-Chih Hsiung, Taichung (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ASIAL OPTICAL CO., INC., Taichung (TW)

(21) Appl. No.: 12/837,728

(22) Filed: Jul. 16, 2010

(30) Foreign Application Priority Data
Jul. 22, 2009 (TW) 98124704

(51) Int. Cl. H04N 5/222

(52) U.S. Cl. 348/333.1; 348/E05.022

(57) ABSTRACT

An electronic playback apparatus. An image pickup unit receives an image of a target imaged through a lens when a photographic mode is in operation. A semiconductor light source module emits a plurality of visible light beams with different bands when a broadcast mode is in operation. A micro-display member receives the visible light beams with the different bands and modulates the visible light beams into an image beam. The image beam is projected onto a screen by the lens.

### CROSS REFERENCE TO RELATED APPLICATIONS

This Application claims priority of Taiwan Patent Application No. 098124704, filed on Jul. 22, 2009, the entirety of which is incorporated by reference herein.

### BACKGROUND OF THE INVENTION

1. Field of the Invention

The invention relates to an electronic playback apparatus, and more particularly to an electronic playback apparatus with a micro-projector.

2. Description of the Related Art

A conventional electronic image-capturing device, such as a digital camera, can be provided with a small size and a light weight and capture images with high definition on demand. Nevertheless, a display attached to the electronic image-capturing device is often provided with a small-sized monitor of at most three inches, wherein the range of a visible angle provided by the monitor is limited. Therefore, when the conventional electronic image-capturing device broadcasts a captured image, it is difficult to share the captured image with many people.

A conventional projector, manufactured by Toshiba, is attached with an image-capturing device for use in video conferencing. The image-capturing device can capture an image of an object. Then, the captured image can be projected onto a screen by the projector and displayed thereon. However, as the image-capturing device and projector are separately disposed, the overall size thereof is large. Furthermore, the image-capturing device attached to the projector can only capture images in a fixed position and cannot capture images in non-fixed positions on demand, such that operation thereof is inconvenient.

Hence, there is a need for an electronic playback apparatus capable of capturing images of any targets and projecting and displaying the same on demand.

### BRIEF SUMMARY OF THE INVENTION

A detailed description is given in the following embodiments with reference to the accompanying drawings.

An exemplary embodiment of the invention provides an electronic playback apparatus comprising a lens, an image pickup unit, a semiconductor light source module, a micro-display member, and a processor. An image of a target is imaged on the image pickup unit through the lens. The image pickup unit and processor save the dynamic or static image of the target as an image file. The semiconductor light source module emits a plurality of visible light beams with different bands to the micro-display member. The processor modulates the micro-display member according to the image file to generate the image beam after the visible light beams with the different bands are reflected by the micro-display member or pass through the micro-display member. Further, the image beam is projected onto a screen by the lens and is magnified thereby.

The electronic playback apparatus further comprises a switching device disposed between the lens and the image pickup unit. When the electronic playback apparatus operates in a photographic mode, the switching device deviates from an optical axis of the lens such that the image of the target is imaged on the image pickup unit by the lens. When the electronic playback apparatus operates in a broadcast mode, the switching device moves onto the optical axis of the lens such that the image beam, from the micro-display member, of the target is reflected to the lens by the switching device and is projected onto the screen.

The electronic playback apparatus further comprises a switching device disposed between the lens and the micro-display member. When the electronic playback apparatus operates in the photographic mode, the switching device moves onto the optical axis of the lens such that the image of the target is imaged by the lens and is reflected to the image pickup unit by the switching device. When the electronic playback apparatus operates in the broadcast mode, the switching device deviates from the optical axis of the lens such that the image beam from the micro-display member is projected onto the screen by the lens.

The main feature of the present electronic playback apparatus is that the image pickup unit and micro-display member are combined with each other and the photographic and broadcast modes performed by the electronic playback apparatus can be switched by the switching device.

The advantages of the present electronic playback apparatus are as follows. The electronic playback apparatus can provide a reduced size, capture images of any targets, and project the captured images to share with many people after the image pickup unit and micro-display member are combined with each other.

### BRIEF DESCRIPTION OF THE DRAWINGS

The invention can be more fully understood by reading the subsequent detailed description and examples with references made to the accompanying drawings, wherein:

FIG. 1A is a schematic view of an electronic playback apparatus of a first embodiment of the invention in a photographic mode;

FIG. 1B is a schematic view of the electronic playback apparatus of the first embodiment of the invention in a broadcast mode;

FIG. 2A is a schematic view of an electronic playback apparatus of a second embodiment of the invention in a photographic mode;

FIG. 2B is a schematic view of the electronic playback apparatus of the second embodiment of the invention in a broadcast mode;

FIG. 3A is a schematic view of an electronic playback apparatus of a third embodiment of the invention in a photographic mode;

FIG. 3B is a schematic view of the electronic playback apparatus of the third embodiment of the invention in a broadcast mode;

FIG. 4A is a schematic view of an electronic playback apparatus of a fourth embodiment of the invention in a photographic mode;

FIG. 4B is a schematic view of the electronic playback apparatus of the fourth embodiment of the invention in a broadcast mode; and

FIG. 5 is a schematic view of a switching device of the electronic playback apparatus of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The following embodiments are given with reference to the specification and drawings of U.S. Pat. No. 7,358,998 owned by the Applicant of the present application.

### First Embodiment

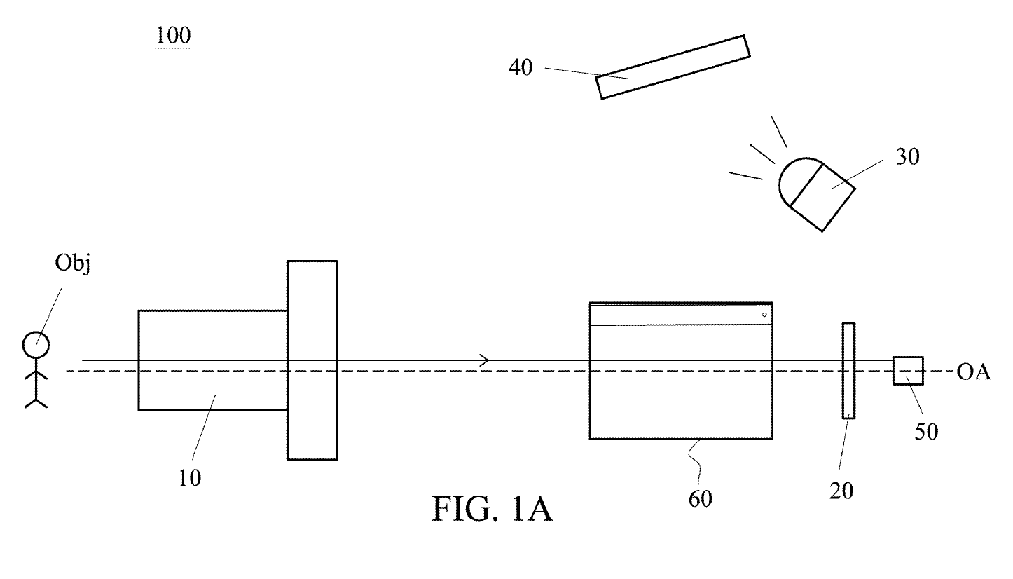

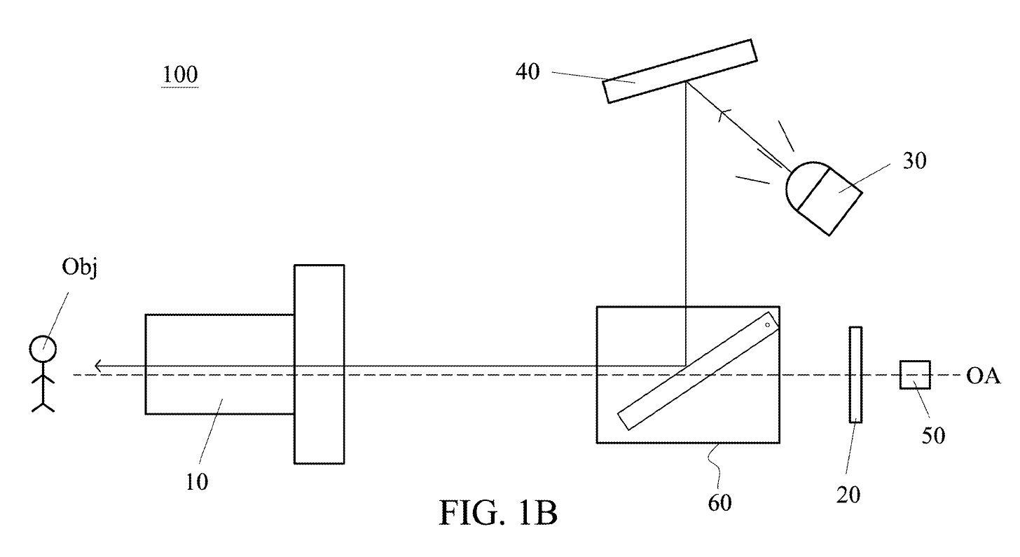

Referring to FIG. 1A and FIG. 1B, an electronic playback apparatus 100 comprises a lens 10, an image pickup unit 20, a semiconductor light source module 30, a micro-display member 40, a processor 50, and a switching device 60 disposed between the lens 10 and the image pickup unit 20.

As shown in FIG. 1A, when the electronic playback apparatus 100 is in a photographic mode, the switching device 60 is parallel to an optical axis OA of the lens 10, such that an image of a target Obj is imaged by the lens 10 and is directly received by the image pickup unit 20. The image pickup unit 20 and processor 50 save the dynamic or static image of the target Obj as an image file, such as a JPEG file, an MPEG file, or an AVI file.

As shown in FIG. 1B, when the electronic playback apparatus 100 is in a broadcast mode, the switching device 60 deviates from the optical axis OA of the lens 10. At this point, the semiconductor light source module 30 emits a plurality of visible light beams with different bands to the micro-display member 40, such as a DMD (digital micro-mirror device) or an LCoS. The processor 50 modulates the micro-display member 40 according to the image file to generate an image beam after the micro-display member 40 reflects the visible light beams with the different bands. The image beam generated by the micro-display member 40 then enters the switching device 60. The switching device 60 reflects the image beam from the micro-display member 40 to the lens 10 and the image beam is magnified by the lens 10 and is projected onto a screen (not shown) thereby.

### Second Embodiment

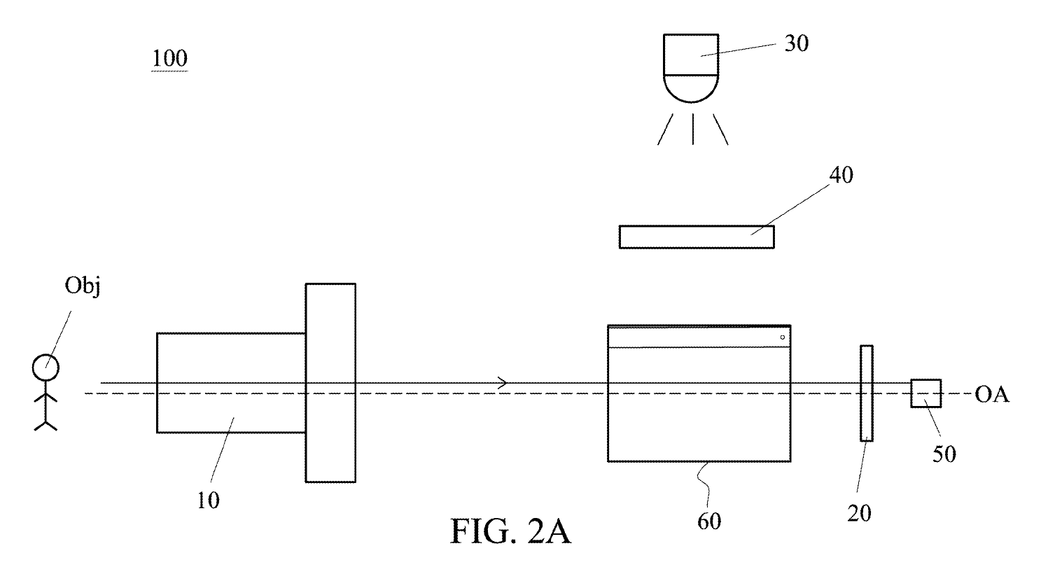

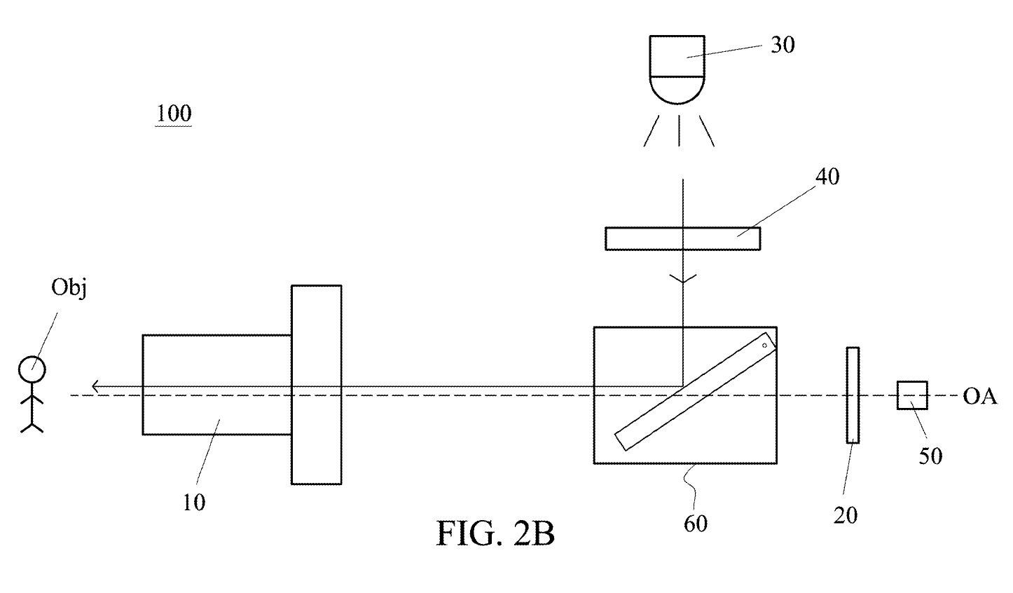

Referring to FIG. 2A and FIG. 2B, an electronic playback apparatus 100 comprises a lens 10, an image pickup unit 20, a semiconductor light source module 30, a micro-display member 40, a processor 50, and a switching device 60 disposed between the lens 10 and the image pickup unit 20.

As shown in FIG. 2A, when the electronic playback apparatus 100 is in a photographic mode, the switching device 60 is parallel to an optical axis OA of the lens 10, such that an image of a target Obj is imaged by the lens 10 and is directly received by the image pickup unit 20. The image pickup unit 20 and processor 50 save the dynamic or static image of the target Obj as an image file, such as a JPEG file, an MPEG file, or an AVI file.

As shown in FIG. 2B, when the electronic playback apparatus 100 is in a broadcast mode, the switching device 60 deviates from the optical axis OA of the lens 10. At this point, the semiconductor light source module 30 emits a plurality of visible light beams with different bands to the micro-display member 40, such as a high-temperature polysilicon (HTPS) LCD panel. The processor 50 modulates the micro-display member 40 according to the image file to generate an image beam after the visible light beams with the different bands pass through the micro-display member 40. The image beam generated by the micro-display member 40 then enters the switching device 60. The switching device 60 reflects the image beam from the micro-display member 40 to the lens 10 and the image beam is magnified by the lens 10 and is projected onto a screen (not shown) thereby.

### Third Embodiment

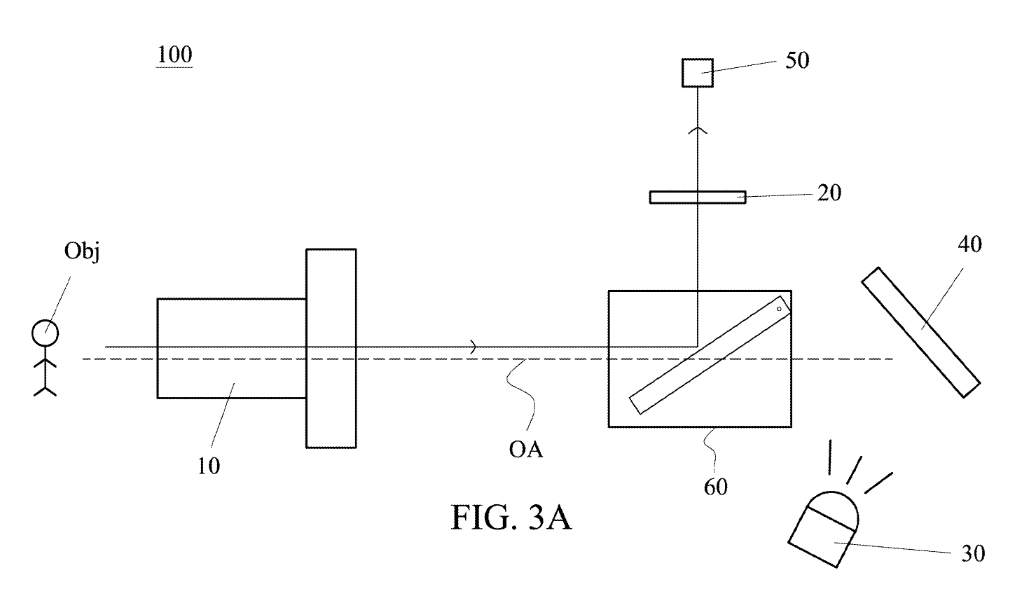

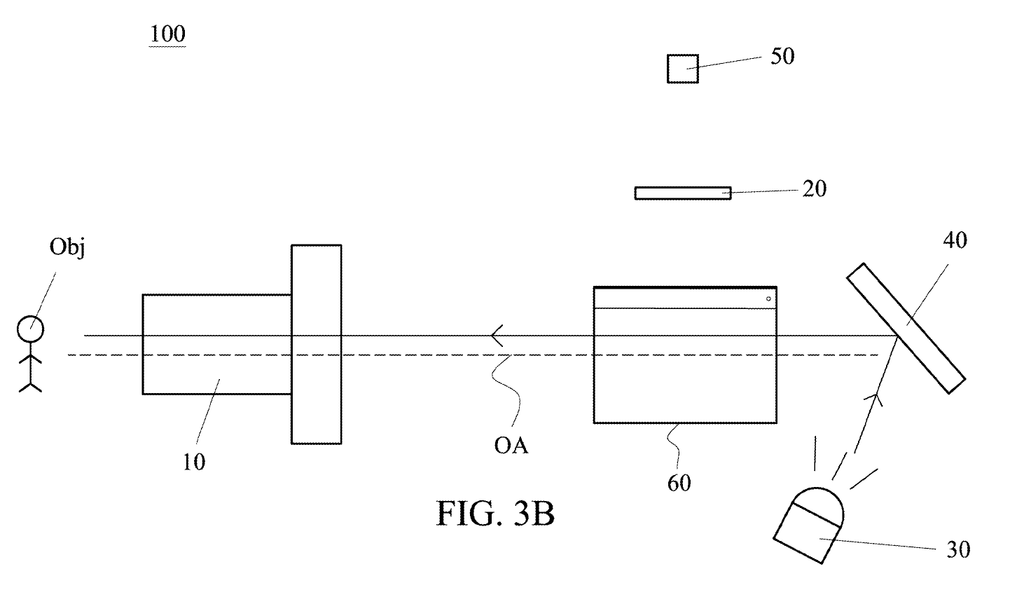

Referring to FIG. 3A and FIG. 3B, an electronic playback apparatus 100 comprises a lens 10, an image pickup unit 20, a semiconductor light source module 30, a micro-display member 40, a processor 50, and a switching device 60 disposed between the lens 10 and the micro-display member 40.

As shown in FIG. 3A, when the electronic playback apparatus 100 is in a photographic mode, the switching device 60 deviates from an optical axis OA of the lens 10, such that an image of a target Obj is imaged by the lens 10 and enters the switching device 60. Then, the image from the lens 10 is reflected to the image pickup unit 20 by the switching device 60 and is received by the image pickup unit 20. The image pickup unit 20 and processor 50 save the dynamic or static image of the target Obj as an image file, such as a JPEG file, an MPEG file, or an AVI file.

As shown in FIG. 3B, when the electronic playback apparatus 100 is in a broadcast mode, the switching device 60 is parallel to the optical axis OA of the lens 10. At this point, the semiconductor light source module 30 emits a plurality of visible light beams with different bands to the micro-display member 40, such as a DMD (digital micro-mirror device) or an LCoS. The processor 50 modulates the micro-display member 40 according to the image file to generate an image beam after the micro-display member 40 reflects the visible light beams with the different bands. Then, the image beam generated by the micro-display member 40 enters the lens 10 and is magnified and projected onto a screen (not shown) by the lens 10.

### Fourth Embodiment

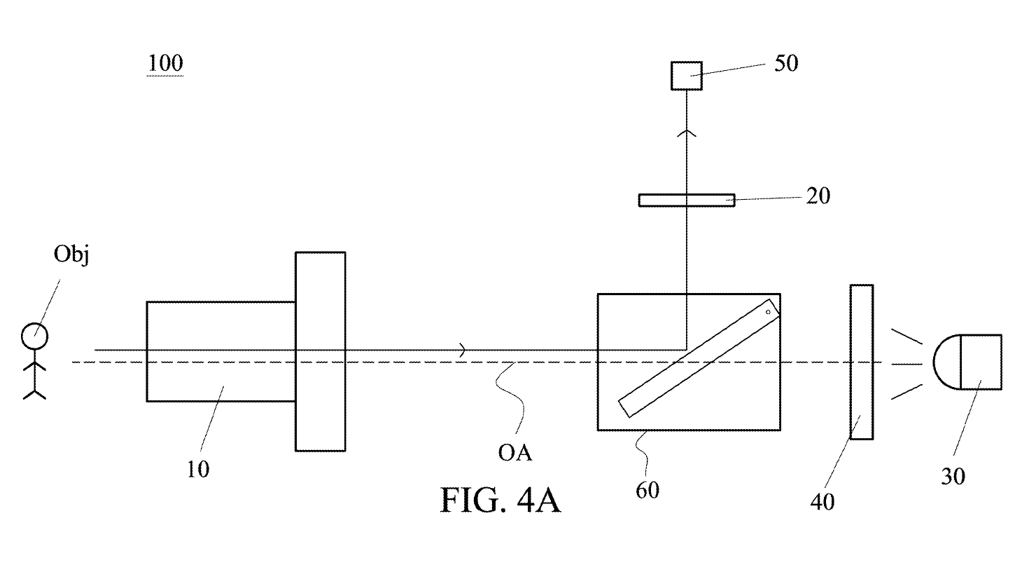

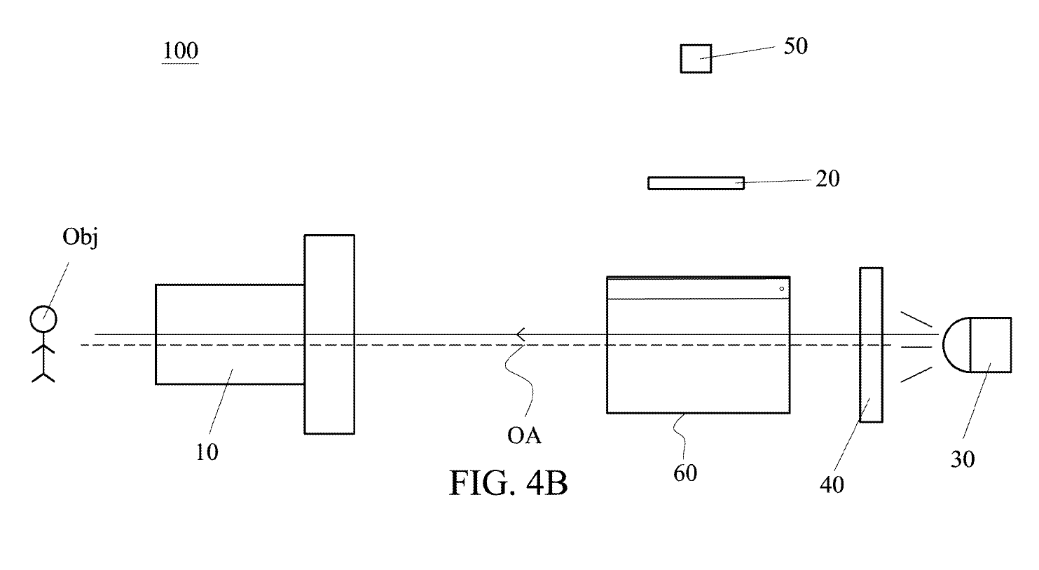

Referring to FIG. 4A and FIG. 4B, an electronic playback apparatus 100 comprises a lens 10, an image pickup unit 20, a semiconductor light source module 30, a micro-display member 40, a processor 50, and a switching device 60 disposed between the lens 10 and the micro-display member 40.

As shown in FIG. 4A, when the electronic playback apparatus 100 is in a photographic mode, the switching device 60 deviates from an optical axis OA of the lens 10, such that an image of a target Obj is imaged by the lens 10 and enters the switching device 60. Then, the image from the lens 10 is reflected to the image pickup unit 20 by the switching device 60 and is received by the image pickup unit 20. The image pickup unit 20 and processor 50 save the dynamic or static image of the target Obj as an image file, such as a JPEG file, an MPEG file, or an AVI file.

As shown in FIG. 4B, when the electronic playback apparatus 100 is in a broadcast mode, the switching device 60 is parallel to the optical axis OA of the lens 10. At this point, the semiconductor light source module 30 emits a plurality of visible light beams with different bands to the micro-display member 40, such as a high-temperature polysilicon (HTPS) LCD panel. The processor 50 modulates the micro-display member 40 according to the image file to generate an image beam after the visible light beams with the different bands pass through the micro-display member 40. Then, the image beam generated by the micro-display member 40 enters the lens 10 and is magnified and projected onto a screen (not shown) by the lens 10.

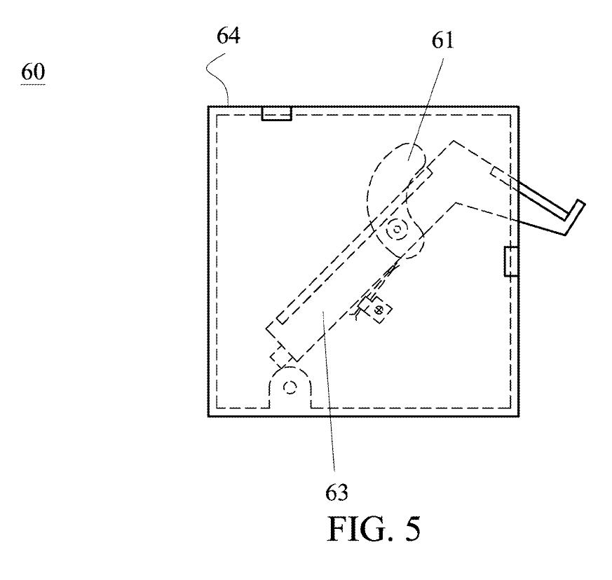

FIG. 5 is a schematic view of a switching device of the electronic playback apparatus of the invention. The switching device 60 described in the above embodiments is also disclosed in U.S. Pat. No. 7,358,998. A reflector 63 of the invention replaces a beam splitter of U.S. Pat. No. 7,358,998, and an optical compensator is not required by the invention. Referring to FIG. 5 of the invention and U.S. Pat. No. 7,358,998, the switching device 60 comprises a main body 64, a reflector 63 rotatably disposed on the main body 64, and a reciprocating driver 61 driving the reflector 63 to rotate. The reflector 63 is rotatably disposed in a first position or a second position by means of the reciprocating driver 61. Specifically, the reciprocating driver 61 may employ multiple linking shafts and a motor, and the linking shafts pivot to the reflector 63 and are combined with the motor. Detailed structural explanation of the switching device can be found in U.S. Pat. No. 7,358,998.

In conclusion, the image pickup unit 20 and micro-display member 40 are disposed together in the electronic playback apparatus 100 and the electronic playback apparatus 100 can be operated between the photographic and broadcast modes using the switching device 60. Thus, the disclosed electronic playback apparatus 100 can provide a small size and a light weight and share the captured images with many people on demand by projection.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic playback apparatus, comprising:
a lens;
an image pickup unit receiving an image of a target imaged through the lens when a photographic mode is in operation;
a semiconductor light source module emitting a plurality of visible light beams with different bands when a broadcast mode is in operation; and
a micro-display member receiving the visible light beams with the different bands and modulating the visible light beams into an image beam, wherein the image beam is projected onto a screen by the lens.

2. The electronic playback apparatus as claimed in claim 1, further comprising a switching device disposed between the lens and the image pickup unit.

3. The electronic playback apparatus as claimed in claim 2, wherein, when the photographic mode is in operation, the switching device deviates from an optical axis of the lens such that the image of the target is imaged on the image pickup unit by the lens, and when the broadcast mode is in operation, the switching device moves onto the optical axis of the lens such that the image beam modulated by the micro-display member is reflected to the lens by the switching device.

4. The electronic playback apparatus as claimed in claim 2, wherein, when the photographic mode is in operation, the switching device moves onto an optical axis of the lens such that the image of the target is imaged by the lens and is reflected to the image pickup unit by the switching device, and when the broadcast mode is in operation, the switching device deviates from the optical axis of the lens such that the image beam modulated by the micro-display member is projected onto the screen by the lens.

5. The electronic playback apparatus as claimed in claim 3, wherein the micro-display member comprises a reflective micro-display member.

6. The electronic playback apparatus as claimed in claim 3, wherein the micro-display member comprises a transmissive micro-display member.

7. The electronic playback apparatus as claimed in claim 4, wherein the micro-display member comprises a reflective micro-display member.

8. The electronic playback apparatus as claimed in claim 4, wherein the micro-display member comprises a transmissive micro-display member.

9. The electronic playback apparatus as claimed in claim 1, further comprising a processor, wherein the processor saves the image, output from the image pickup unit, of the target as an image file when the photographic mode is in operation, and the processor modulates the micro-display member according to the image file to generate the image beam when the broadcast mode is in operation.
